(19) United States
(12) Patent Application Publication
(10) Pub. No.: US 2008/0174880 A1
(43) Pub. Date: Jul. 24, 2008

(54) Zoom lens

(76) Inventor: Kaori Shimizu, Saitama-shi (JP)

Correspondence Address: JACOBSON HOLMAN PLLC, 400 SEVENTH STREET N.W., SUITE 600, WASHINGTON, DC, 20004, US

(21) Appl. No.: 12/003,297

(22) Filed: Dec. 21, 2007

(30) Foreign Application Priority Data
Dec. 25, 2006 (JP) 2006-347822

(51) Int. Cl. G02B 15/14

(52) U.S. Cl. 359/676

(57) ABSTRACT

The present invention is directed to a “negative lead type” zoom lens advantageous for downsizing the entire lens system, which has a high zoom ratio and provides superior compensation for aberration, retaining a predetermined back focal distance. The zoom lens has at least a first or leading lens unit of negative refractive power and a second or succeeding lens unit of positive refractive power in this order from the view point closer to a photographed object. The first lens unit is of two positive lens pieces and three negative lens pieces while the second lens unit provides an aspherical surface, having a positive lens piece in the second foremost position closer to a photographed object. During the zooming from a wide-angle view to a tele-photo view, a separation between the first and second lens unit is reduced. The first lens unit serves as a focusing lens, and the zoom lens satisfies requirements as expressed in the formulae 3.0<ft/fw<4.9 where fw is a focal length at the wide-angle view end, and ft is the focal length at the tele-photo view end.

### FIELD OF THE INVENTION

The present invention relates to a zoom lens, and more particularly, it relates to a so-called “negative lead type” zoom lens where a leading lens unit is of negative refractive power, which is suitable for use as a photographing lens dedicated to single-lens reflex cameras that usually require a relatively elongated back focal distance.

### BACKGROUND ART

A zoom lens, which is beneficial to downsizing the entire optics, encounters a difficulty in raising a zoom ratio if configured with three or less component lens units.

An exemplary prior art “negative lead type” zoom lens is taught in Patent Document 1 listed below that it is provided with three component lens units separately displaced to attain the zooming, having an effective zoom ratio of 2.34. In Patent Document 2, disclosed is another “negative lead type” zoom lens of increased coverage angle that is configured with three or 1st to 3rd component lens units where the 1st or leading component lens unit has a smaller number of lens pieces, and such a “negative lead type” zoom lens is 2.87 and 2.83 in effective zoom ratio.

Additionally, in Patent Document 3, another compact “negative lead type” zoom lens with three component lens units, as a whole, is disclosed, and the zoom lens is downsized by appropriate reconfiguration of lens pieces in each of the component lens units, still having a zoom ratio of 2.68 and 2.69.

### LIST OF CITED PRIOR ART DOCUMENT

Patent Document 1: Japanese Patent Preliminary Publication No. H1-189622
Patent Document 2: Japanese Patent Preliminary Publication No. H5-173073
Patent Document 3: Japanese Patent Preliminary Publication No. H5-27171

In order to raise the zoom ratio of any of the prior art “negative lead type” zoom lenses, it is necessary to relocate the 1st and 2nd lens units to separate farther from each other. However, widening a distance between the 1st and 2nd lens units leads to worsening various types of aberration and/or results in more bulky lens. Specifically, with the 1st and 2nd lens units separated farther from each other, light beams pass the 1st lens unit at more abaxial points, and this necessitates an enlargement of a lens diameter and/or causes high-order aberration. Since the leading 1st lens unit having negative refractive power causes the transmitted light flux to diverge, such diverging light beams, when incident upon the succeeding 2nd lens unit, are at further more abaxial points, which also necessitates an enlargement of the lens diameter and/or causes the high-order aberration.

As to digital single-lens reflex cameras that have been drastically prevailing for recent years, a lens usually provide a smaller image circle than that for silver film cameras, and hence, it is necessary to attain a shorter focal length to obtain an equivalent coverage angle to that achieved by the silver film camera lens. Simply referring for lens data of the silver film cameras and comparatively reducing the focal length of the lens for the single-lens reflex cameras so as to compete with the silver film camera lens in the coverage angle, a back focal distance is accordingly reduced. As a consequence, the resultant lens is no longer suitable for the single-lens reflex cameras that require a constant back focal length.

The 1st lens unit of negative refractive power, if having its refractivity enhanced, may have a greater back focal distance, but simply augmenting the refractivity leads to a worsened aberration, especially, to adverse effects in the high-order aberration to cause difficulties in compensating for the aberration.

The longer distance between the 1st and 2nd lens units and the enhanced refractive power of the 1st lens unit together produce a synergic effect of the aggravated high-order aberration.

The present invention is made to overcome the above-mentioned disadvantages in the prior art “negative lead type” zoom lens, and accordingly, it is an object of the present invention to provide a “negative lead type” zoom lens advantageous for downsizing the entire optics, which has a high zoom ratio and provides superior compensation for aberration, retaining a predetermined back focal distance.

### SUMMARY OF THE INVENTION

The present invention is directed to a zoom lens having at least a first or leading lens unit of negative refractive power and a second or succeeding lens unit of positive refractive power in this order from the view point closer to the photographed object. The first lens unit is of two positive lens pieces and three negative lens pieces while the second lens unit provides an aspherical surface, having a positive lens piece in the second foremost position closer to a photographed object. During the zooming from a wide-angle view to a tele-photo view, a separation between the first and second lens unit is reduced. The first lens unit serves as a focusing lens, and the zoom lens satisfies requirements as expressed in the following formulae:

3.0<ft/fw<4.9

where fw is a focal length at the wide-angle view end, and ft is the focal length at the tele-photo view end.

Referred to as “lens” herein is any component member that has its surface coated to serve as a lens or its equivalent.

The “negative lead type” zoom lens in accordance with the present invention is advantageous in downsizing the entire optics, has a high zoom ratio, and provides superior compensation for aberration, retaining a predetermined back focal distance.

In the case that the above formula 3.0<ft/fw is not satisfied in the context of the present invention, an inessential lens piece(s) must be added, and this results in not only an increase in the manufacturing cost but a degradation of performances such as transmissivity. In addition, in the event that the above formula ft/fw<4.9 is not satisfied in the context of the present invention, the “negative lead type” zoom lens becomes bulky as a whole, and it is hard compensating for distortion aberration, comatic aberration, astigmatism, and/or spherical aberration.

The three negative lens pieces in the first lens unit usefully divide and take over an overburden of the refractivity that the lens unit should have owed to a single negative lens piece. As a consequence, a reduced high-order aberration is experienced in comatic aberration, astigmatism, and distortion aberration. Since this arrangement with three negative lens pieces is also useful for reducing a curvature of a concave surface, an occurrence of the spherical aberration in the tele-photo mode can be effectively minimized. With two or less negative lens pieces in the first lens unit, the curvature of the concave surface is increased, and this brings about adverse effects, including an occurrence of the high-order aberration in comatic aberration and the like. When a glass material of high refractive power is used to fabricate the lens pieces by way of counterbalancing an increase in the curvature, the glass material of higher refractive power has an increased light dispersion property, and thus, chromatic aberration are unavoidable to aggravate.

The positive lens pieces incorporated in the first lens unit serve to compensate for distortion aberration. The most significant cause of negative distortion aberration at the wide-angle view end is the first or leading lens unit, and in order to cope with the aberration, effectively used is a positive lens piece(s) in positions where light beams fall on at a greater incident angle and at far abaxial level. With an arrangement where the positive lens piece is disposed in the second and third foremost positions closer to the photographed object, the distortion aberration is effectively compensated, and relocating the positive lens piece(s) to the foremost or closest to the photographed object works better.

The second lens unit is arranged to have an aspherical surface, thereby achieving good spherical aberration throughout the zoom range. In general, the zoom lens of three or less component lens unit encounters a difficulty in retaining good spherical aberration in the entire zoom range. After the spherical aberration is corrected in two points both at the wide-angle view end and at the tele-photo view end, it will be found that the focusing is poor due to the spherical aberration somewhere along the intermediate focal distance between both the ends. To compensate for this, the second lens unit must be arranged to have an aspherical surface where the transmitted light flux is at more abaxial position, so that the spherical aberration can be effectively corrected.

The exemplary zoom lens is designed to permit the first lens unit to serve as a focusing lens, thereby resulting in a lens barrel being relatively of simple configuration. In general, when the foremost or leading lens unit closest to the photographed object is displaced for the focusing, the displacement for a certain distance is almost fixed throughout the zoom range. Consequently, the lens barrel mechanism can be of relative simple configuration.

Preferred embodiments of the present invention will now be outlined.

(1) The exemplary zoom lens is characterized in that there are three of component lens units, namely, 1st to 3rd lens units. Especially with the 3rd lens unit, the zoom lens achieves a high zoom ratio and a tolerable aberration that the zoom lens of two-lens-unit configuration could not attain. Otherwise, the zoom lens of the present invention can realize a bright lens, retaining the remaining superior optical performances. As the zoom ratio increases, an ability of the two-lens-unit zoom lens to compensate for aberration fades. In this event, the spherical aberration at the tele-photo view is especially a matter of concern, and the 3rd lens unit is useful to correct the spherical aberration.

(2) An aperture stop is located between the 1st and 2nd lens units. Meeting this configuration requirement, the zoom lens permits the light flux to pass through the center of the aperture even when the minimum shooting distance is further reduced. If the minimum shooting distance is relatively long, the aperture stop is not necessarily located immediately before the 2nd lens unit. With the reduced minimum shooting distance, however, the aperture stop must be disposed immediately before the 2nd lens unit so that the light flux to produce the maximized image height at the wide-angle view end is forced to pass the center of the aperture stop.

(3) The exemplary zoom lens is characterized in that the third foremost lens piece of the 2nd lens unit is a positive lens. With this positive lens in the 2nd lens unit, replacing the second foremost lens piece with an additional positive lens in the 2nd lens unit enables significantly diverging incident light beams from the 1st lens unit to be converged. If the refractive power of the second foremost lens piece in the 2nd lens unit is insufficient to converge the considerably diverging incident light beams from the 1st lens unit, the foremost lens piece closest to the photographed object in the 2nd lens unit may be replaced with a further additional positive lens.

(4) The exemplary zoom lens is characterized in that the second foremost lens piece in the 2nd lens unit is a positive meniscus lens having its convex surface oriented toward the photographed object. With such a positive meniscus lens in the 2nd lens unit, spherical aberration and comatic aberration are prevented from aggravating.

(5) The exemplary zoom lens is characterized by the leading or 1st lens unit having optical performances as expressed below:

1.1<|f1/fw|<2.1

where f1 is a focal length of the 1st lens unit, and fw is the focal length of the entire optics in the wide-angle mode. Appropriately determining the focal length of the 1st lens unit results in the entire lens system keeping downsized while attaining the desired back-focusing. Furthermore, distortion aberration and comatic aberration can be minimized to occur. When the requirement expressed in the above formula 1.1<|f1/fw| is not satisfied, aberration during the zooming is greatly varied to cause difficulties in compensating for the aberration. When the requirement as in the formula |f1/fw|<2.1 is not met, the back focal distance is reduced, and it is no longer suitable for cameras like a single-lens reflex camera that require a fixed back focal distance throughout the zooming range.

(6) The exemplary zoom lens is characterized by optical performances as expressed in the following formulae:

1.5<BFw/fw<2.3

where BFw is a back focal distance in the wide-angle mode while fw is a focal length in the same mode. In the case that the requirement as in the formula 1.5<BFw/fw is not satisfied, the back focal distance is reduced, and thus, the zoom lens is no longer suitable for single-lens reflex cameras that mechanically require a fixed back focal distance. In the case that the requirement as in the formula BFw/fw<2.3 is not met, the entire length of the lens is increased at the wide-angle view end, and this results in the 1st lens unit unavoidably being bulky.

(7) The exemplary zoom lens is characterized in that, during the zooming from the wide-angle view to the tele-photo view, a distance between the 2nd and 3rd lens units is increased. In this manner, comatic flare can be efficiently blocked without providing an additional component(s) such as a light-shielding diaphragm. Although this is preferable to implement an optical system including optical components as small in number as possible, it may be replaced with the light-shielding diaphragm disposed in the 3rd lens unit in a position closer to an imaging field.

(8) The exemplary zoom lens is characterized by optical performances as expressed in the following formulae:

1.0<f3/ft<3.5

where f3 is a focal length of the 3rd lens unit, and ft is the focal length of the entire system in the telephoto mode. When the requirement in the formula 1.0<f3/ft is not satisfied, due to an increase in a positive refractive power of the 3rd lens unit, the back focal distance in the wide-angle view mode is reduced, and the zoom lens is no longer suitable for single-lens reflex cameras that require a back focal length equal to a certain distance or even longer. This also causes difficulties in correcting comatic aberration. When the requirement as expressed in the formula f3/ft<3.5 is not met, the controlled focusing is less effective due to a reduction of the positive refractive power in the 3rd lens unit, the focusing point of the entire system is shifted to that for the tele-photo view setting. Even if the refractive power is raised in the 1st and 2nd lens units, there arise difficulties in compensating for some type of aberration such as distorting aberration.

### BRIEF DESCRIPTION OF THE DRAWINGS

FIG. 1 depicts an optical arrangement of a first embodiment of the present invention where a so-called “negative lead type” zoom lens 10 is in zooming operation;

FIG. 2 depicts various types of aberration caused in the “negative lead type” zoom lens of the first embodiment in the wide-angle mode;

FIG. 3 depicts the various types of aberration caused in the “negative lead type” zoom lens of the first embodiment in the tele-photo mode;

FIG. 4 depicts an optical arrangement of a second embodiment of the present invention where the so-called “negative lead type” zoom lens 110 is in zooming operation;

FIG. 5 depicts various types of aberration caused in the “negative lead type” zoom lens of the second embodiment in the wide-angle mode; and

FIG. 6 depicts the various types of aberration caused in the “negative lead type” zoom lens of the second embodiment in the tele-photo mode.

### BEST MODE OF THE INVENTION

### Embodiment 1

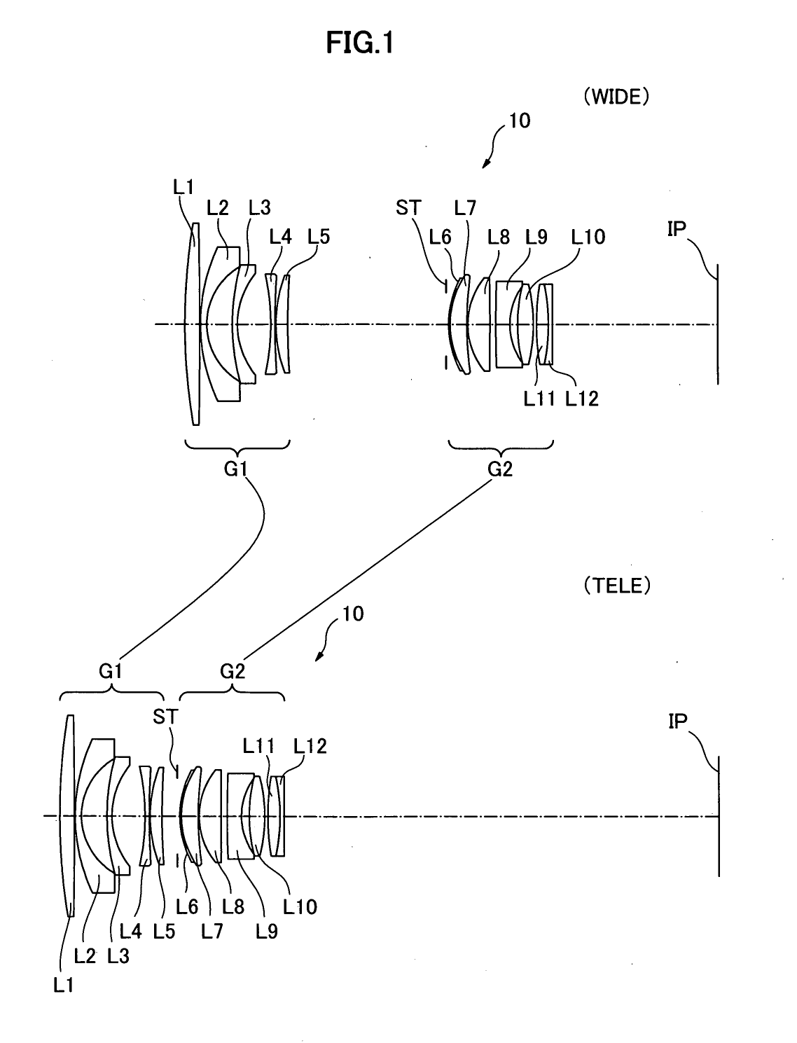

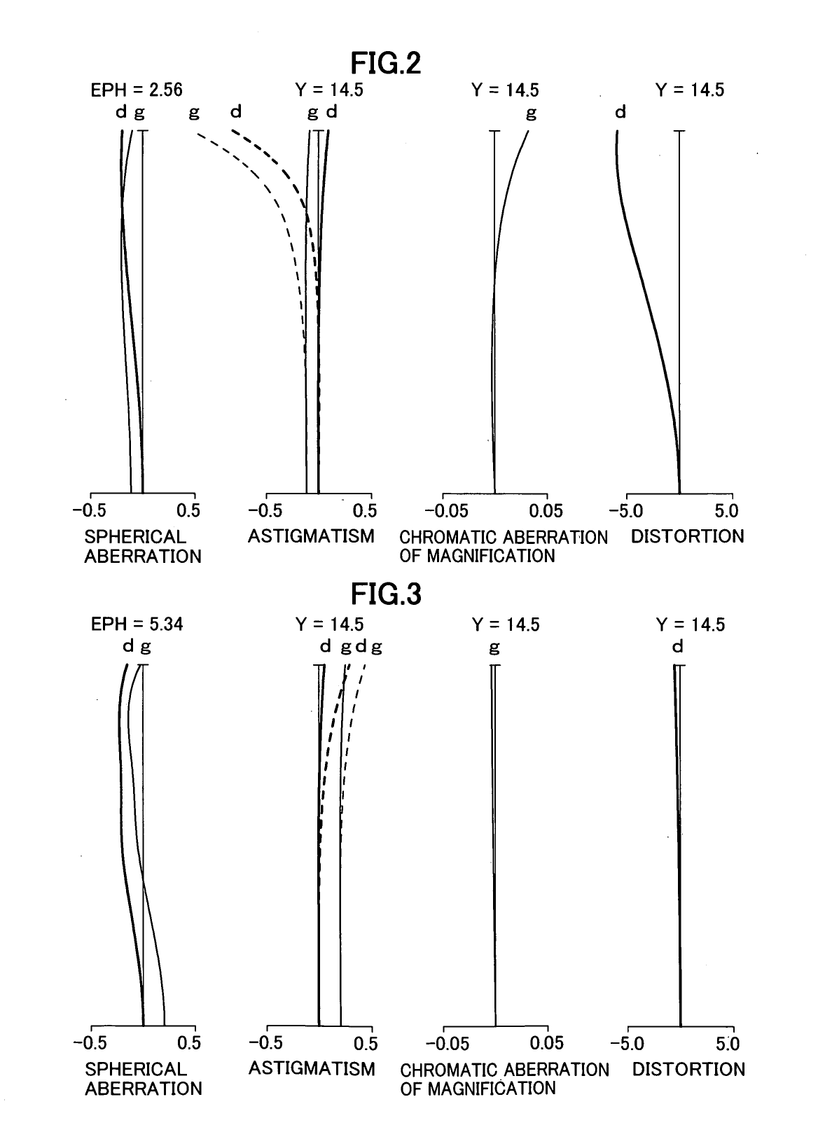

In conjunction with the accompanying drawings, described now will be a first embodiment of a “negative lead type” zoom lens with two lens units in accordance with the present invention. FIG. 1 is a diagram depicting an optical arrangement of the exemplary negative lead type zoom lens 10 during the zooming. FIG. 2 illustrates various types of aberration caused in the negative lead type zoom lens 10 in the wide-angle mode. FIG. 3 illustrates the various types of aberration caused in the negative lead type zoom lens 10 in the tele-photo mode.

The first embodiment of the negative lead type two-unit zoom lens 10, as shown in FIG. 1, includes a leading 1st lens unit G1 of negative refractive power and a succeeding 2nd lens unit G2 of positive refractive power. IP designates an imaging plane.

The 1st lens unit G1 includes a first lens piece L1 of positive refractive power, a second lens piece L2 of negative refractive power, a third lens piece L3 of negative refractive power, a fourth lens piece L4 of negative refractive power, and a fifth lens piece L5 of positive refractive power.

The 2nd lens unit G2 has a two-fold lens where a sixth lens piece L6 has an aspherical surface and is affixed as a coating to a seventh lens piece L7 that is a positive meniscus lens with its convex surface oriented toward the photographed object, and the 2nd lens unit G2 further has an eighth lens piece L8 of positive refractive power, a ninth lens piece L9, a tenth lens piece L10, and an additional two-fold lens with eleventh and twelfth lens pieces L11 and L12 affixed to each other.

An aperture stop ST is located immediately before the sixth lens piece L6 of the 2nd lens unit G2 on the side closer to the photographed object. Listed below are optical parameters of the first embodiment of the negative lead type two-unit zoom lens 10 with two lens units.

Reference symbols are used in the lists where f is a focal length, Fno is an F number, 2ω is an angle of coverage (in degrees), No is a surface number, R is a curvature of radius, d is an interval, Nd is a refractive index of d-line, and ν is an Abbe number. Aspherical surfaces are defined as in the following formula, and an asterisk (*) is suffixed onto the surface number in the optical parameters:

$$X = \frac{{H}^{2} / R}{1 + \sqrt{1 - ( ɛ {H}^{2} / {R}^{2} )}} + {AH}^{2} + {BH}^{4} + {CH}^{6} + {DH}^{8} + {EH}^{10}$$

where X is a shape of an aspherical surface, R is a curvature of radius, ε is a constant of the cone, H is a height from the optical axis, and A to E denote a coefficient of an aspherical surface with their respective various digits of precision. Although lengths are indicated in millimeters, other units may be substituted as desired.

f = 18.36~35.50~68.60
Fno = 3.59~4.46~5.77
2ω = 76.6~44.4~23.9
Zoom Ratio 3.74

| NO | R | d | Nd | ν |
|---|---|---|---|---|
| 1 | 154.0788 | 3.5319 | 1.58913 | 61.2 |
| 2 | −1302.27 | 0.2 | | |
| 3 | 43.9422 | 1.5 | 1.58913 | 61.2 |
| 4 | 16.1572 | 6.1278 | | |
| 5 | 53.6391 | 1.2 | 1.69680 | 55.5 |
| 6 | 19.6741 | 7.9701 | | |
| 7 | −55.021 | 1.0 | 1.69680 | 55.5 |
| 8 | 197.8946 | 0.2 | | |
| 9 | 33.5014 | 2.8515 | 1.75520 | 27.5 |
| 10 | 181.6534 | D (10) | | |
| 11 | INF | 0.6 | | |
| 12* | 22.7464 | 0.35 | 1.51460 | 50.0 |
| 13 | 21.7073 | 4.0205 | 1.48749 | 70.2 |
| 14 | 88.422 | 0.2 | | |
| 15 | 17.9562 | 5.3119 | 1.48749 | 70.2 |
| 16 | −830.4971 | 1.4043 | | |
| 17 | 295.9558 | 3.3744 | 1.83400 | 37.2 |
| 18 | 15.7226 | 1.8722 | | |
| 19 | 39.8399 | 3.697 | 1.58913 | 61.2 |
| 20 | −40.1639 | 0.7632 | | |
| 21 | 61.533 | 2.8807 | 1.48749 | 70.2 |
| 22 | −46.9959 | 0.9943 | 1.65844 | 50.9 |
| 23 | −16233.4189 | | | |

Variable Intervals

| | f = 18.36 | f = 35.50 | f = 68.60 |
|---|---|---|---|
| D (10) | 37.6473 | 15.2302 | 3.6362 |

Data of Aspherical Surface
Surface No. 12

| ε | A | B | C | D | E |
|---|---|---|---|---|---|
| 0.3893 | 0.00000E+00 | −4.87038E−06 | −1.74854E−08 | −1.33023E−10 | −5.59729E−13 |

The negative lead type zoom lens 10 causes various types of aberration as shown in FIGS. 2 and 3. In aberration graphs of FIGS. 2 and 3, EPH denotes an entrance pupil radius, Y designates an image circle radius, d is d-line, and g is g-line. The solid line in the aspherical aberration graph expresses sagittal ray while the broken line does meridional ray. Any of lengths is expressed in millimeters. Spherical aberration, astigmatism, and chromatic aberration of magnification are quantified in units of millimeters while distortion aberration is expressed as percentage (%).

### Embodiment 2

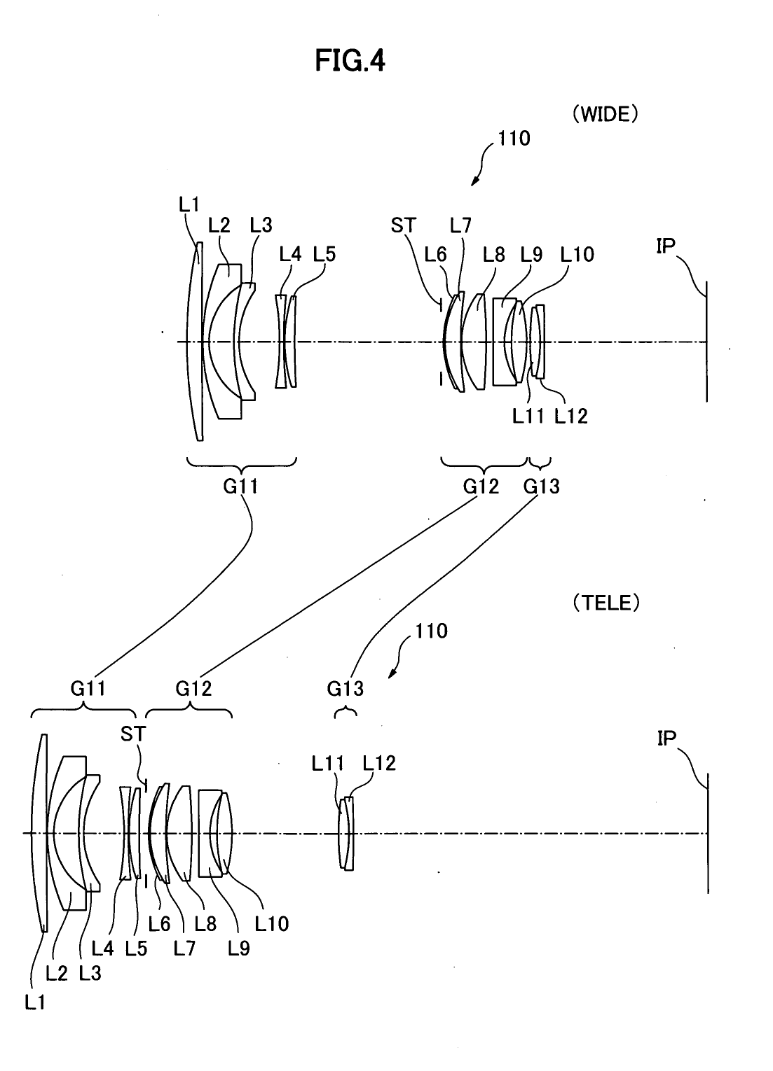

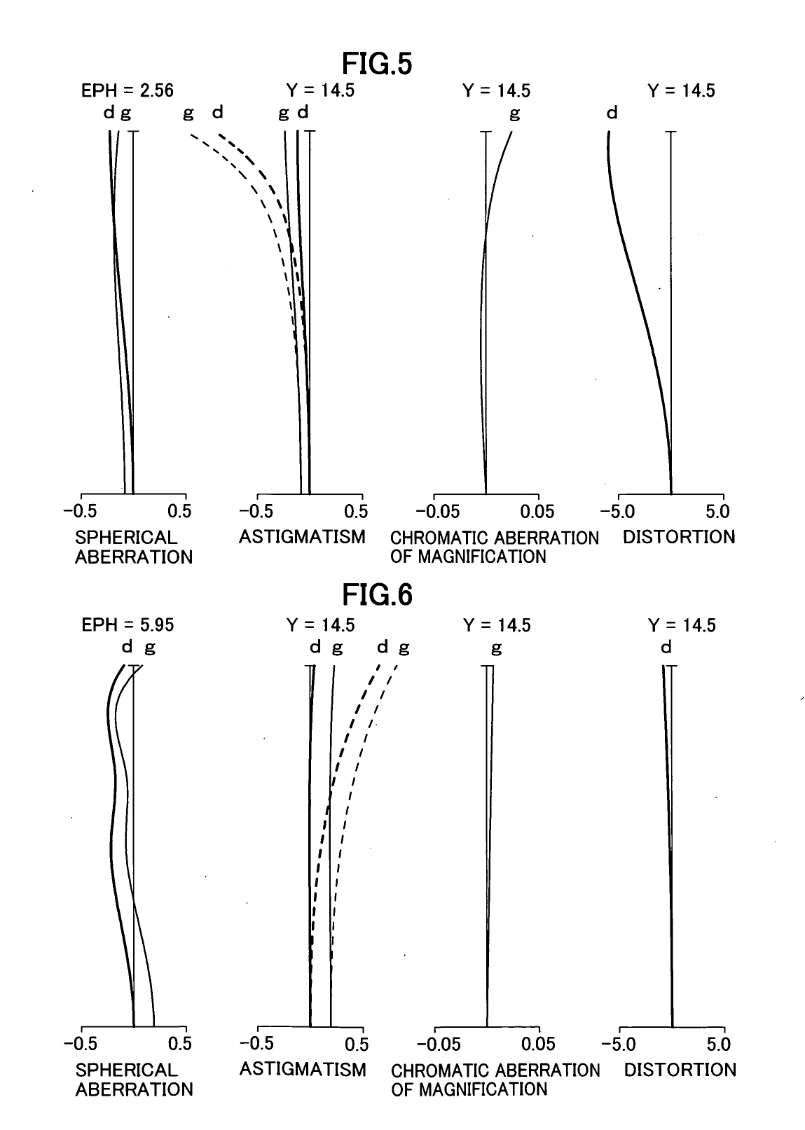

Detailed below with reference to the drawings will be another embodiment or a second embodiment of the “negative lead type” zoom lens with three lens units according to the present invention. FIG. 4 depicts an optical arrangement of the second embodiment of the negative lead type zoom lens 110 during the zooming. FIG. 5 depicts various types of aberration of the second embodiment of the negative lead type zoom lens in the wide-angle mode. FIG. 6 depicts the various types of aberration of the same in the tele-photo mode.

The second embodiment of the negative lead type zoom lens 110, as shown in FIG. 4, includes a 1st lens unit G1 of negative refractive power, a 2nd lens unit G12 of positive refractive power, and a 3rd lens unit G13 having multi lens pieces affixed into a unity. IP denotes an imaging plane.

The 1st lens unit G11 includes a first lens piece L1 of positive refractive power, a second lens piece L2 of negative refractive power, a third lens piece L3 of negative refractive power, a fourth lens piece L4 of negative refractive power, and a fifth lens piece L5 of positive refractive power.

The 2nd lens unit G12 includes a two-fold lens where a sixth lens piece L6 has an aspherical surface and is affixed as a coating to a seventh lens piece L7 that is a positive meniscus lens with its convex surface oriented toward the photographed object, and the 2nd lens unit G12 further has an eighth lens piece L8 of positive refractive power, a ninth lens piece L9, and a tenth lens piece L10.

The 3rd lens unit G13 includes eleventh and twelfth lens pieces L11 and L12.

An aperture stop ST is located immediate before the sixth lens piece L6 of the 2nd lens unit G12 on the side closer to the photographed object.

Listed below are optical parameters of the second embodiment of the negative lead type two-unit zoom lens 110. Reference symbols denoting the parameters are similar to those of the first embodiment.

f = 18.36~35.50~68.60
Fno = 3.59~4.46~5.77
2ω = 76.6~44.4~23.9
Zoom Ratio 3.74

| NO | R | d | Nd | ν |
|---|---|---|---|---|
| 1 | 113.3056 | 3.6156 | 1.58913 | 61.2 |
| 2 | 2865.2581 | 0.2 | | |
| 3 | 47.3748 | 1.5 | 1.58913 | 61.2 |
| 4 | 16.0008 | 5.9737 | | |
| 5 | 54.3678 | 1.2 | 1.69680 | 55.5 |
| 6 | 21.9129 | 9.6439 | | |
| 7 | −64.9854 | 1.0 | 1.69680 | 55.5 |
| 8 | 115.8786 | 0.2 | | |
| 9 | 36.8981 | 2.3933 | 1.75520 | 27.5 |
| 10 | 228.6068 | d (10) | | |
| 11 | INF | 0.6 | | |
| 12* | 23.6382 | 0.35 | 1.51460 | 50.0 |
| 13 | 22.4055 | 3.7468 | 1.48749 | 70.2 |
| 14 | 86.8691 | 0.1998 | | |
| 15 | 19.2598 | 5.9705 | 1.48749 | 70.2 |
| 16 | −135.7434 | 1.6956 | | |
| 17 | −7015.6152 | 2.6709 | 1.83400 | 37.2 |
| 18 | 16.9817 | 1.6919 | | |
| 19 | 39.4638 | 3.6251 | 1.58913 | 61.2 |
| 20 | −36.4395 | d (20) | | |
| 21 | 68.16 | 2.4268 | 1.48749 | 70.2 |
| 22 | −34.3521 | 0.9992 | 1.65844 | 50.9 |
| 23 | −534.4549 | | | |

Variable Intervals

| | f = 18.36 | f = 35.50 | f = 68.60 |
|---|---|---|---|
| d (10) | 34.7553 | 12.8638 | 1.6129 |
| d (20) | 0.7989 | 7.3054 | 25.1677 |

Data of Aspherical Surface
Surface No. 12

| ε | A | B | C | D | E |
|---|---|---|---|---|---|
| 0.0121 | 0.00000E+00 | −3.04774E−06 | −2.08782E−08 | 1.53018E−10 | −6.12965E−13 |

The negative lead type zoom lens 110 causes various types of aberration as shown in FIGS. 5 and 6. Reference symbols to the parameters are similar to those of the first embodiment.

1. A zoom lens comprising at least a first or leading lens unit of negative refractive power and a second or succeeding lens unit of positive refractive power, disposed in this order from a view point closer to a photographed object,
the first lens unit including two positive lens pieces and three negative lens pieces while the second lens unit provides an aspherical surface, having a positive lens piece in the second foremost position closer to the photographed object,
during the zooming from a wide-angle view to a tele-photo view, a separation between the first and second lens unit being reduced, and the first lens unit serving as a focusing lens,
the zoom lens satisfying requirements as expressed in the following formulae:
3.0<ft/fw<4.9
where fw is a focal length at the wide-angle view end, and ft is the focal length at the tele-photo view end.

2. A zoom lens according to claim 1, further comprising a third lens unit.

3. A zoom lens according to claim 1, wherein an aperture stop is located between the 1st and 2nd lens units.

4. A zoom lens according to claim 1, wherein the third foremost lens piece in the second lens unit closer to the photographed object serves as a positive lens.

5. A zoom lens according to claim 1, wherein the second foremost lens piece in the second lens unit is a positive meniscus lens having its convex surface oriented toward the photographed object.

6. A zoom lens according to claim 1, wherein the zoom lens satisfies requirements as expressed in the following formulae:
1.1<|f1/fw|<2.1
where f1 is a focal length of the 1st lens unit, and fw is the focal length of the entire optics at the wide-angle view end.

7. A zoom lens according to claim 1, wherein the zoom lens satisfies requirements as expressed in the following formulae:
1.5<BFw/fw<2.3
where BFw is a back focal distance at the wide-angle view end while fw is a focal length at the wide-angle view end.

8. A zoom lens according to claim 2, wherein, during the zooming from the wide-angle view to the tele-photo view, a distance between the 2nd and 3rd lens units is increased.

9. A zoom lens according to claim 2, wherein the zoom lens satisfies requirements as expressed in the following formulae:
1.0<f3/ft<3.5
where f3 is a focal length of the 3rd lens unit, and ft is the focal length of the entire system at the tele-photo view end.
